(19) United States
(12) Patent Application Publication
(10) Pub. No.: US 2017/0090438 A1
(43) Pub. Date: Mar. 30, 2017

(54) Sensorless Fan and Pump Speed Control Device and Method

(71) Applicant: Mingsheng Liu, Omaha, NE (US)

(72) Inventor: Mingsheng Liu, Omaha, NE (US)

(21) Appl. No.: 14/866,815

(22) Filed: Sep. 25, 2015

(51) Int. Cl. G05B 15/02; F04B 49/06

(52) U.S. Cl. CPC G05B 15/02; F04B 49/065; G05B 2219/45219

(57) ABSTRACT

A method for controlling at least one fan or pump of a system having at least one variable frequency speed drive. The method comprises inputting into a controller a plurality of design conditions and VFD operating variables. The controller determines a plurality of measured conditions based on the design conditions and operating variables including a measured head value, efficiency value, and flow rate value. The controller activates or deactivates the at least one fan or pump based on a comparison of a pump or fan performance curve working point and an efficiency value and a comparison of a ratio of the measured head value over a square of the measured flow rate to a ratio of a design head value over a square of a design flow rate, and modulates the speed of at least one fan and pump based on a comparison of the measured and design flow rates.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The disclosed embodiments generally relate to any process that uses fans and pumps to transport air, gas, water, and/or liquid, and more particularly to the fans of air handling units, the pumps of hot and chilled water systems, condensing water systems, water treatment systems, and city water distribution systems.

### DESCRIPTION OF THE RELATED ART

Many types of buildings require the use of air handling unit (AHUs) systems to supply air at specific temperatures to indoor spaces. Buildings also use chilled water systems to condition rooms at a set temperature but use water as part of the cooling process. Over the years, a variety of configurations and methods for controlling AHUs and chilled and hot water pump systems have been proposed.

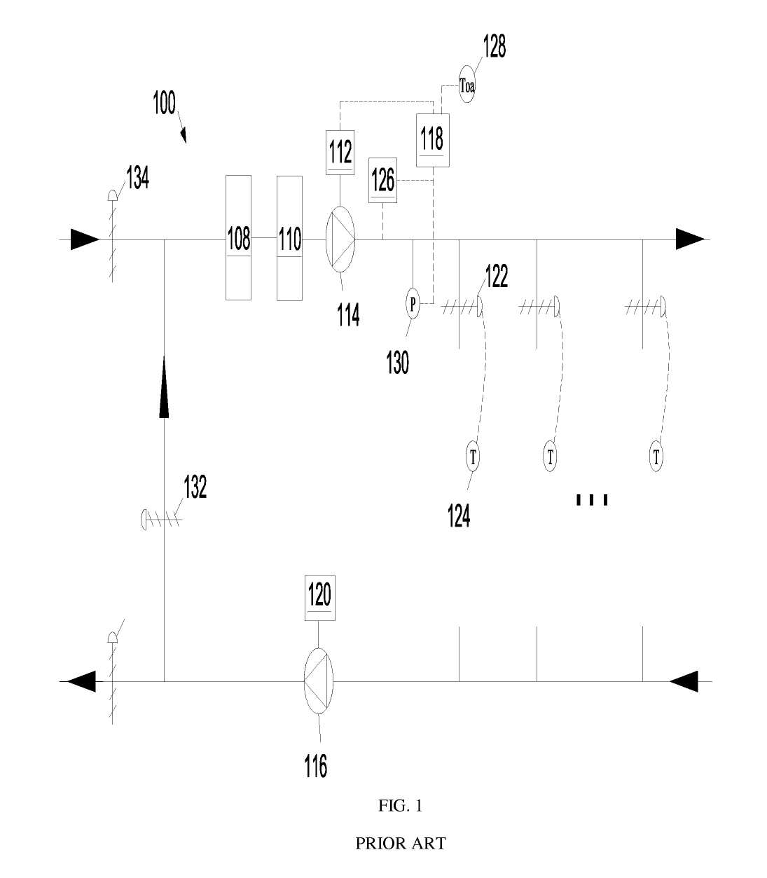

FIG. 1 is an example of one such prior art fan speed control system for controlling single duct variable air volume air handling units. Outdoor air enters into outdoor air damper 134 of prior art air handling unit 100 and mixes with the return air from return air damper 132. It is then drawn as supply air through AHU 100 by supply air fan 114. The temperature at which the outdoor air enters AHU 100 is measured by outdoor air temperature sensor 128. Supply air fan 114 draws supply air through heating coil 108 and cooling coil 110 where it is heated or cooled at the desired temperature so that it can be distributed to end users. Fan 114 also draws air through a device that measures the air flow rate such as flow station 126 shown in FIG. 1. Eventually, the air makes its way through the ductwork to the zone dampers. Zone Damper 122 is configured in the ductwork and controls the amount of air delivered to the end user (in each zone/building/area). At least one temperature sensor (such as temperature sensor 124) is typically installed in the zone served by AHU 100 to measure the ambient temperature of said zone.

Controller 118 receives signals from outdoor air temperature sensor 128, static pressure sensor 130, and flow station 126. It then uses that information to control air handling unit 100. In VAV AHUs (variable air volume air handling units), the set point of the supply air temperature is maintained at 55° F. (the temperature is adjustable, and not limited to that stated herein) using the dampers, heating coils, and cooling coils. Static pressure sensor 130 is installed upstream of the zone dampers and measures the static pressure downstream of the supply air duct. Supply air fan 114 is driven by VFD 112. The supply fan speed is modulated to maintain the static pressure at a constant set point value. VFD 120 controls the speed of return air fan 116 to ensure that the building has a slightly positive pressure.

Although prior art air handling units have been controlled to cool spaces in building interiors, they are not very energy efficient. In particular, prior art air handling units like the one described are controlled to maintain the static pressure set point at a constant value. As a result, the system over-pressurizes the terminal box dampers. In some cases, the static pressure setpoint is reset based on the outdoor air temperature. Since the outdoor air temperature is not representative of all the factors that could influence the static pressure, this reset often ends quite conservatively or leads to occupant comfort related complaints. Notably, in such systems the static pressure sensor is located downstream of the ductwork above the ceiling inside of the building. This thus makes it difficult to find issues and perform maintenance procedures. Another problem is that under partial load conditions, the static pressure is very high. A high static pressure can lead to over-pressurization and cause the terminal box to malfunction. Excessive air leakage in the ductwork and terminal box dampers may also waste energy (by 20%) and increase fan energy consumption by half. In some prior art systems, the fan speed is controlled through pre-selection of the terminal box damper position. However, the problem with this method is that some zones may not attain the same comfort standard as others and it can't be ensured that the preselected zone is is a critical zone.

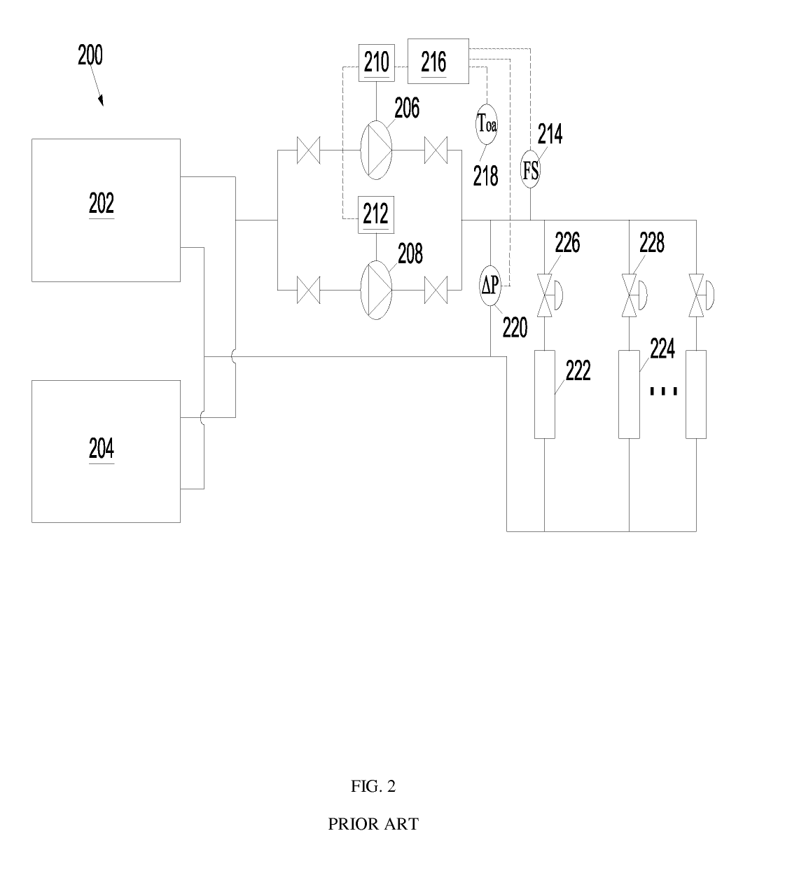

FIG. 2 is a schematic diagram of a typical chilled water pump system in the prior art. Chilled water pump system 200 as shown in FIG. 2 is comprised of chillers 202 and 204. The chillers are configured to produce chilled water that is circulated by pumps 206 and 208 throughout system 200. VFDs 210 and 212 are configured in connection with the pumps and function to modulate the pump speed at partial load conditions. The components of system 200 are controlled by controller 216. Controller 216 receives signals from outdoor air temperature sensor 218, loop differential pressure sensor 220, and flow meter 214. The collected signal information is used by Controller 216 to control the pump speed at partial load conditions. Outdoor air temperature sensor 218 is often mounted outside the building to measure the outdoor temperature. Flow station 214 monitors the water flow rate of system 200. Valves 226 and 228 open and close to cool down the air passing through cooling coils 222 and 224.

As shown in the Fig., a plurality of sensors and a flow station is included in the configuration of the chilled water pump system. The pump speed is controlled to maintain the set point of the loop differential pressure. Such prior art pump systems activate and deactivate based on the distribution of water in the pump system. If the loop differential pressure is lower than the setpoint when the pumps are running at full speed, for example, controller 216 activates one or more pumps to provide more water to system 200. When the pump speed is low, the one or more pumps are deactivated. The set point is reset based on the outdoor air temperature or determined according to the prior experiences of the user. It should be noted that since the outdoor air temperature is not the only factor that influences the set point and setting the set point based on knowledge gained through prior experience is not a method that is entirely reliable, the reset in prior art systems tends to be very conservative. The result of this is that the chilled water system consumes more energy.

Additionally, in prior art pump systems such as the one described, the pump working points are often pushed to the position of lowest efficiency as a result of improper pump staging. Thus, even if the design pump efficiency is 75%, in actuality it operates at a low efficiency of 40%. Under partial load conditions, excessive pressure head is often exerted on the cooling coil control valves as well. The pumps consume an excessive amount of energy as a result of the excessive differential pressure set points. As a result, the control valve either gets stuck open or closed (and wastes energy). Otherwise, the control valve must be manually adjusted into position (resulting in extra labor). Prior art systems also tend to have excessively high differential pressure set points that lead to significant pump energy consumption. Finally, prior art systems use differential pressure sensors. These sensors require a lot of maintenance in order to function properly.

In order to solve the issues present in the prior art as well as to increase the energy efficiency of air handling unit and chilled water systems, a novel control system and method is proposed. This control system controls the fan speed of air handling units and the pump speed and staging in chilled water pump systems, thus eliminating the need for the installation of sensors and other system components that are used to help perform these tasks in prior art units.

Accordingly, it is one aspect of an embodiment to improve the energy efficiency of and reduce the costs associated with air handling units and chilled water pump systems. This is accomplished through the addition of a control system that reduces the number of pressure sensors, outdoor air temperatures sensors, flow stations, and static pressure sensors needed.

### DRAWINGS REFERENCE NUMERALS

### Prior Art

100 Prior Art Air Handling Unit
108 Heating Coil
110 Cooling Coil
112 & 120 Variable Frequency Drives (VFDs)
114 Supply Air Fan
116 Return Air Fan
118 Air Handling Unit Controller
122 Damper (end user)
124 Temperature Sensor
126 Flow Station
128 Outdoor Air Temperature Sensor
130 Static Pressure Sensor
132 Return Air Damper
134 Outdoor Air Damper
200 Prior Art Chilled Water Pump System
202 & 204 Chillers
206 & 208 Pumps
210 & 212 Variable Frequency Drives (VFDs)
214 Flow Station
216 System Controller
218 Outdoor Air Temperature Sensor
220 Differential Pressure Sensor
222 & 224 Cooling Coils
226 & 228 Valves
300 Sensorless Fan and Pump Control Device in a VAV Air Handling Unit
302 Sensorless Fan and Pump Control Device
304 & 316 VFDs
306 Supply Fan
308 Cooling Coil
310 Heating Coil
312 Return Fan
314 & 318 Dampers
320 Temperature Sensor
400 Sensorless Fan and Pump Control Device in a Chilled Water Pump System
408 & 426 VFDs
404 & 406 Chillers
410 & 412 Chilled Water Pumps
414, 416, 418 Valves
420, 422, 424 Cooling Coils
500 Control Logic of the Sensorless Fan and Pump Control Device
502 Input Module
504 AHU Power Module
506 Air Flow, Head, and Fan Efficiency Module
508 AHU Load/Unload Module
510 Fan and Design Efficiency Comparison Step
512 Fan Ratio Comparison Step
514 Pump Power Module
516 Water Flow, Head, and Pump Efficiency Module
517 Chiller Number Calculation Step
518 Pump Load/Unload Module
520 Fan Activation Step
522 Fan De-activation Step
524 Pump and Design Efficiency Comparison Step
526 Pump Ratio Comparison Step
528 Pump Activation Step
530 Pump De-activation Step
532 Fan Speed Control Module
534 Pump Speed Control Module
536 Fan Airflow and High Load Airflow Rate Comparison Step
538 h/Q²=hd/Qd² Fan Speed Modulation Step
540 Fan Airflow and Low Load Airflow Rate Comparison Step
542 Low Load Airflow Rate Fan Speed Modulation Step
544

$$\frac{h}{{Q}^{2 }} = ( 1 + \frac{{Q}_{h} - Q}{α {Q}_{h}} ) \frac{{h}_{d}}{{Q}_{d}^{2}}$$

### Fan Speed Modulation Step

546 Pump Water flow and High Load Water flow Rate Comparison Step
548 h/Q²=hd/Qd² Pump Speed Modulation Step
550 Pump Airflow and Low Load Water flow Rate Comparison Step
552 Low Load Water flow Rate Pump Speed Modulation Step
554

$$\frac{h}{{Q}^{2 }} = ( 1 + \frac{{Q}_{h} - Q}{α {Q}_{h}} ) \frac{{h}_{d}}{{Q}_{d}^{2}}$$

### Pump Speed Modulation Step

600 Flow chart showing how control device 302 may be connected and operable to control multiple VFDs.

### SUMMARY

In one embodiment, a control system for controlling at least one fan or pump and at least one VFD is provided. The control system comprises an input module configured to input a plurality of operating conditions from said vfd and predetermined variables for said system comprising a performance curve, a design flow rate, a design low load flow rate, a design high load flow rate, a VFD current value, a VFD power value, a VFD torque value, and a VFD speed value. The control system also comprises a power module configured to calculate for a measured power value based on the VFD power value, as well as a head, flow rate, and efficiency module configured to calculate for a head value based on the measured power value and the performance curve. It is also configured to calculate for a measured flow rate value based on the VFD current value, VFD power value, VFD torque value, the performance curve, as well as an efficiency value based on the measured flow rate and measured head value.

The control system further comprises a load/unload module configured to stage and modulate a speed of said at least one pump or fan. The control system comprises an identifying step for identifying a working point on the performance curve. It also comprises an activation step for activating the at least one fan or pump when the efficiency value is less than the working point by a predetermined amount and a ratio of the measured head value over a square of the measured flow rate is lower than a ratio of the design head value over a square of the design flow rate. The control system further comprises a deactivation step for deactivating the at least one fan or pump when the efficiency value is less than the working point by a predetermined amount and a ratio of the measured head value over a square of the measured flow rate is greater than a ratio of the design head value over a square of the design flow rate.

Finally, the control system comprises a speed modulation step for controlling a speed of the at least one fan or pump when the measured flow rate is greater than the design high load flow rate so that a ratio of the measured head value over a square of the measured flow rate is equal to a ratio of the design head value over a square of the design flow rate. The control system includes a speed modulation step for controlling a speed of the at least one fan or pump to maintain the low load flow rate when the measured flow rate is less than the low load flow rate. The control system also comprises a speed modulation step for controlling a speed of the at least one fan or pump when the measured flow rate is less than the design high load rate and greater than the design low load rate so that the ratio of the measured head value over a square of the measured flow rate is equal to one plus said design high load flow rate minus said measured flow rate over said design high load flow rate multiplied by a distribution factor and further multiplied by said design head over said design flow rate squared. For clarity, this is shown in equation form as:

$$[ \frac{h}{{Q}^{2 }} = ( 1 + \frac{{Q}_{h} - Q}{α {Q}_{h}} ) \frac{{h}_{d}}{{Q}_{d}^{2}} ]$$

In another embodiment, a method of controlling at least one fan or pump to optimize the transport of liquids and/or gases through a system having at least one VFD is proposed. The method comprises interfacing a control device with the system. It further comprises inputting a plurality of system operating conditions comprising a VFD power value, a VFD current value, VFD torque value, and VFD speed value from the variable speed drive into said control device. It also comprises inputting a plurality of operating conditions such as a performance curve, a design flow rate, a design high load flow rate and design low load flow rate into the control device. The method further comprises calculating, by the controller, for a measured power value based on theVFD power value. The method also comprises determining a measured flow rate based on the performance curve, the VFD current value, VFD power value, and VFD torque value.

The method further comprises determining a measured head value based on the measured power value and the performance curve, and determining a design point efficiency based on the measured flow rate and measured head value. The method further comprises identifying a working point efficiency on the performance curve, and activating the at least one fan or pump when the design point efficiency is less than the working point efficiency by a predetermined amount, and a ratio of the measured head value over a square of the measured flow rate is lower than a ratio of the design head value over a square of the design flow rate.

The method further comprises inactivating at least one fan or pump when the design point efficiency is less than the working point efficiency within a predetermined range and a ratio of the measured head value over a square of the measured flow rate is greater than a ratio of the design head value over a square of the design flow rate. The method comprises modulating the fan and pump to maintain the low load flow rate when the measured flow rate is lower than the design low load flow rate. It further comprises modulating a speed of the at least one fan or pump so that a ratio of the measured head value over a square of the measured flow rate is equal to a ratio of the design head value over a square of the design flow rate when the measured flow rate is greater than the design high load flow rate.

Finally, the method comprises modulating a speed of the at least one fan or pump when the measured flow rate is less than the design high load rate and greater than the design low load rate, so that a ratio of the measured head value over a square of the measured flow is equal to one plus the design high load flow minus the measured flow rate over the design high load flow multiplied by a distribution factor and further multiplied by the design head over the design flow rate squared. For clarity, this is shown in equation form as:

$$[ \frac{h}{{Q}^{2 }} = ( 1 + \frac{{Q}_{h} - Q}{α {Q}_{h}} ) \frac{{h}_{d}}{{Q}_{d}^{2}} ] .$$

In some embodiments the system is an air handling unit while in other embodiments the system is a chilled water pump system having at least one chiller. In embodiments in which the system is a chilled water pump system having at least one chiller, the controller calculates for the design water flow rate and measured head of the at least one chiller.

### BRIEF DESCRIPTION OF THE DRAWINGS

It will be appreciated that for simplicity and clarity of illustration, elements illustrated in the following Figures have not necessarily been drawn to scale. For example, the dimensions of some of the elements are exaggerated relative to other elements for clarity. Advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a schematic diagram embodying the principles of an air handling unit system in the prior art.

FIG. 2 is a schematic diagram embodying the principles of a chilled water pump system in the prior art.

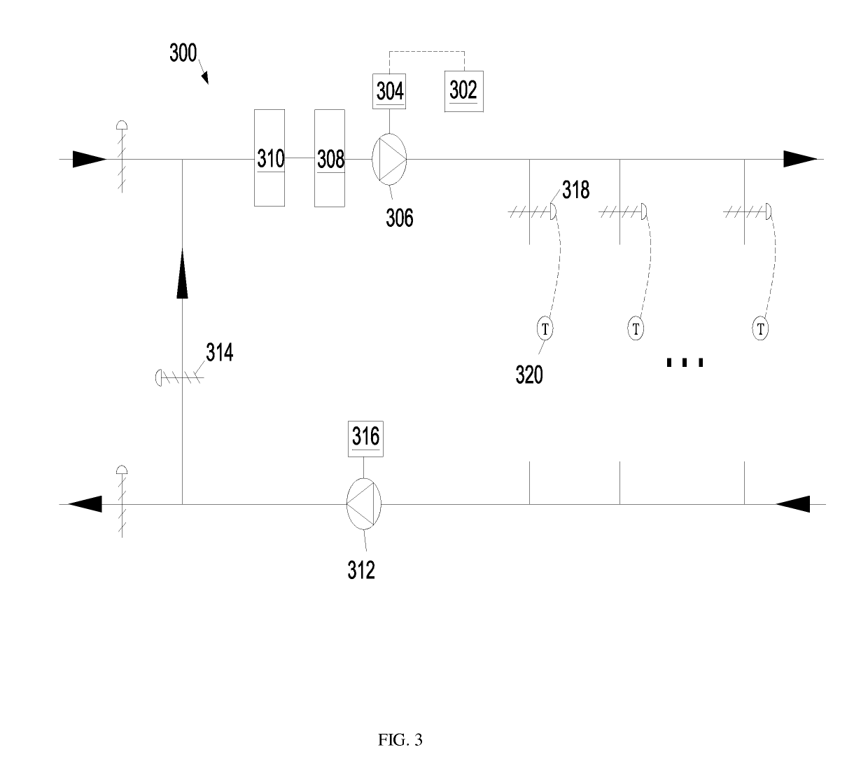

FIG. 3 is a schematic diagram embodying the principles of a sensorless fan and pump speed control device implemented in an air handling unit.

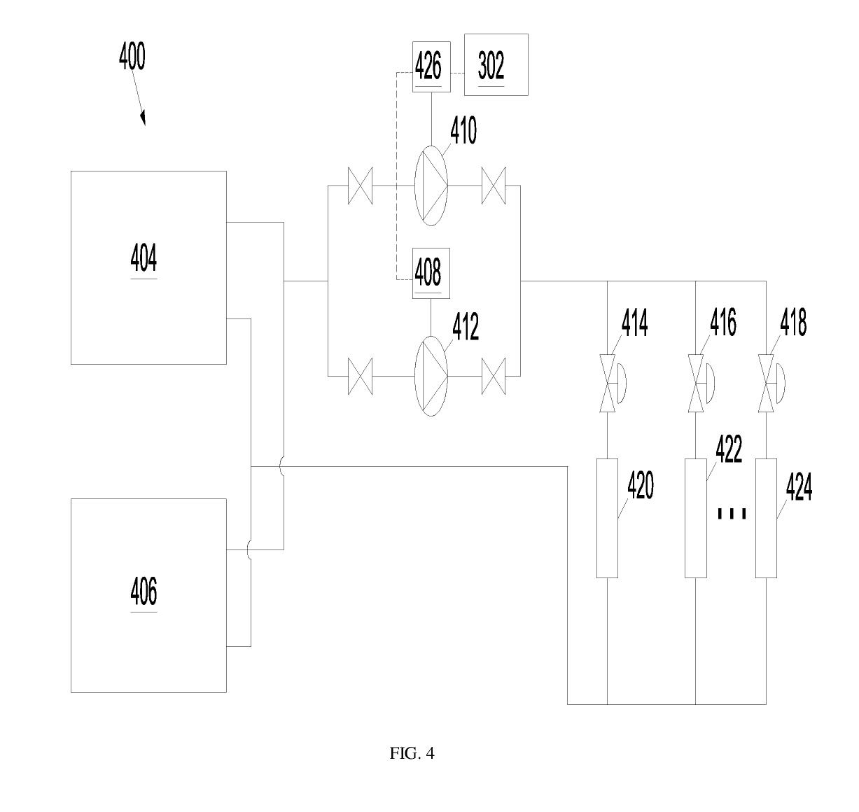

FIG. 4 is a schematic diagram embodying the principles of said sensorless fan and pump speed control device implemented in a chilled water pump system.

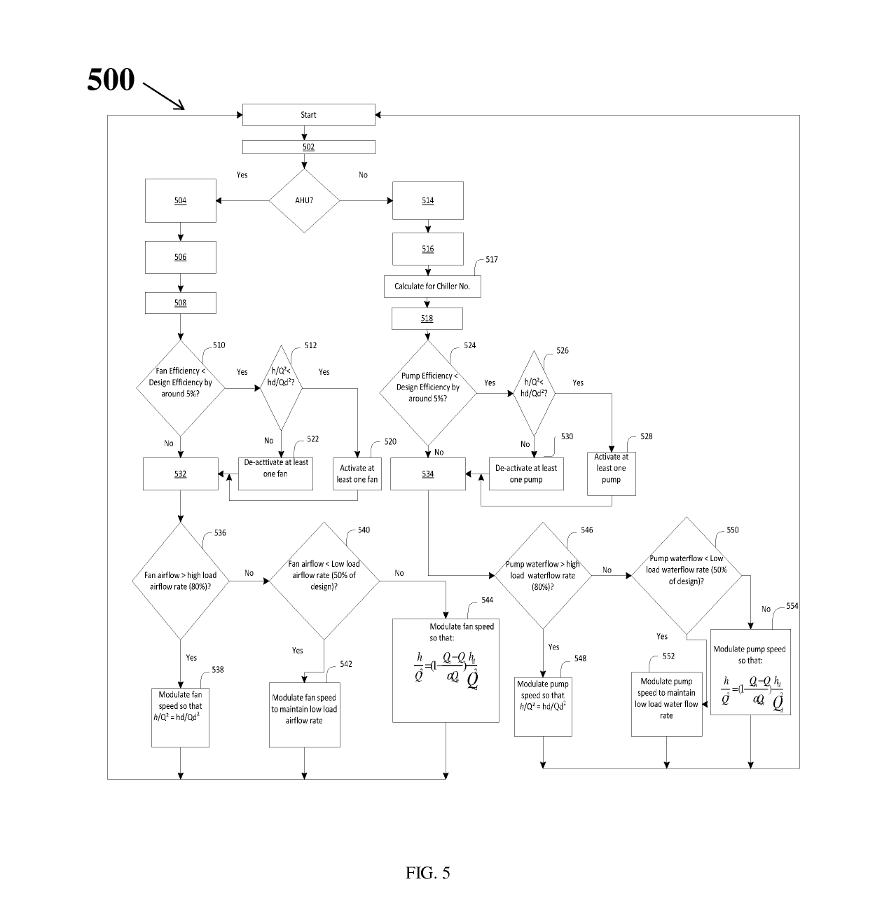

FIG. 5 is a block diagram showing the the control logic of said sensorless fan and pump speed control device.

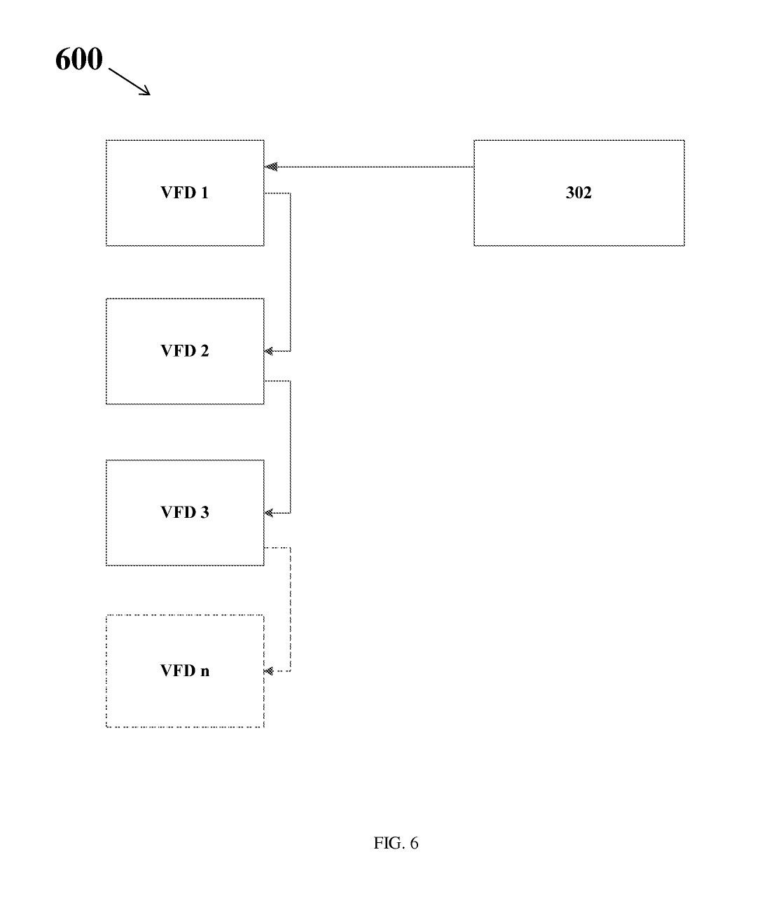

FIG. 6 is a block diagram showing the direction of communication between control device 302 and the variable frequency drive(s) of the system in which it is implemented.

### DETAILED DESCRIPTION

Before the present methods, systems, and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a”, “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

In accordance with one embodiment, a sensorless fan and pump speed control air handling unit system is illustrated in FIG. 3. In the embodiment shown, control device 302 is implemented in air handling unit system 300. As shown in the Figure, existing air handling unit system 300 is comprised of supply air fan 306, cooling coil 308, heating coil 310, return air fan 312, temperature sensor 320, and return air dampers and end user dampers 314 & 318. Fans 306 and 312 are connected in communication with VFDs 304 and 316. Based on commands from controller 302, VFDs 304 and 316 are able to control the speed of fans 306 and 312, respectively. FIG. 6 (flow chart 600) shows how control device 302 may be connected and operable to control multiple VFDs through use of the Modbus communication protocol or other communication channel. In the Fig., the fans are configured in parallel and are powered by multiple VFDs. In other embodiments, however, device 302 can also be configured in communication with a single VFD.

In accordance with another embodiment, a sensorless fan and pump speed control system 400 is illustrated in FIG. 4. In the embodiment shown, control device 302 is implemented in chilled water pump system 400. System 400 is comprised of VFDs 408 & 426, chillers 404 & 406, supply water pumps 410 and 412, valves 414, 416, and 418 and cooling coils 420, 422, and 424.

Chillers 404 and 406 produce chilled water that is circulated throughout system 400 as well as to valves 414, 416, and 418 and cooling coils 420, 422, and 424 by pumps 410 and 412. When water passes through cooling coils 420, 422, and 424, it is warmed up by the air. The water is then once again redistributed through the pump system in a cyclical manner and is cooled down by chillers 404 and 406. VFDs 408 & 426 control the speed of pumps 410 and 412 to maintain the differential pressure across cooling coils 420, 422, and 424. Control device 302 is configured in communication with VFDs 408 and 426. Said control device controls the manner in which pumps 410 and 412 are staged. It is also configured to control the speed of said pumps. As illustrated in FIG. 4, the pumps are configured in parallel.

As shown in FIG. 3, control device 302 can be installed in both systems 300 and 400. Before control device 302 can be used, the user must first configure control device 302 with the specific data for the system in which it will be implemented. For example, when the system is implemented in air handling units, the user pre-programs into device 302 data comprising but not limited to the fan performance curve and high and low load airflow rates. When the system is implemented in chilled water pump systems, data pre-programmed into device 302 may include but not be limited to the chilled water pump performance curves and the high and low load water flow rates. Thus, the control method of device 302 differs depending upon the system of implementation. In FIG. 3, Device 302 is shown to be installed in communication with VFD 304 of system 300.

FIG. 5 is a block diagram showing the control logic of control device 302. Control device 302 may include a plurality of modules. The modules have different functions depending on whether Device 302 is implemented in a chilled water pump system or in an air handling unit. As shown in FIG. 5, Device 302 includes an input module 502 that is configured to receive a plurality of digital or analog signals dictating the operating conditions of system 300 or 400 (depending upon in which system it is implemented) from the one or more VFDs. The analog or digital signals may be delivered to control device 302 wirelessly or via wire connection. In a method of the embodiment, the collected operating conditions may include data detailing the current, power, torque, and speed values from the VFD(s) as well as set information that is pre-programmed into Device 302 by the user to include but not be limited to the fan and pump performance curves and the high and low load flow rates. Based on information on the VFD power values, AHU Power Module 504 calculates for the fan power values by removing the VFD loss and motor loss from the VFD power values. If device 302 is implemented in a chilled water pump system, Pump Power Module 514 similarly calculates for the pump power values by removing the VFD loss and motor loss from the VFD power values.

Using the pump performance curve and the current, power, and torque values collected from the VFD(s), Air Flow, Fan Head, and Fan Efficiency Module 506 calculates for an airflow rate when used in system 300. Device 302 calculates for a water flow rate for a chilled water pump system such as system 400 in Water Flow, Pump Head, and Pump Efficiency Module 516 using the same method as in Module 506. Modules 516 and 506 also calculate for the pump head and pump efficiency (in chilled water pump systems) and the fan head and fan efficiency (in air handling units) values, respectively. The fan or pump power values (calculated in modules 504 or 514, respectively) as well as the fan or pump performance curve (fan curve if device 302 is implemented in system 300 and pump curve if implemented in system 400) are used by Modules 506 and 516 to calculate for the fan head and fan efficiency or the pump head and pump efficiency, respectively.

Using the fan head and air flow rates calculated in Module 506 or the pump head and water flow rates calculated in Module 516, AHU Load/Unload Module 508 or Pump System Load/Unload Module 518 identifies the equivalent working points on the fan or pump design curves, respectively. The pump design curve is used if device 302 is implemented in a pump system or the fan design curve is employed if device 302 is implemented in an air handling unit. As shown in steps 510 and 512 of FIG. 5, if the fan efficiency is less than the design efficiency by a predetermined value (about 5% for example, but not limited to this percentage), then AHU Load/Unload Module 508 activates the fans by comparing the ratio of the measured fan head over the square of the measured fan airflow rate to the ratio of the design fan head over a square of the design fan airflow rate. Module 508 activates a fan if the ratio of the measured fan head over the square of the measured fan airflow rate is lower than the ratio of the design fan head over the square of the design fan airflow rate (see step 520 in FIG. 5). Module 508 inactivates a fan if the working point is on the left of the design point meaning that the ratio of the measured fan head over a square of the measured fan airflow rate is higher than the ratio of the design fan head over a square of the design fan airflow rate (see step 522 in FIG. 5). It should be noted though that AHU Load/Unload Module 508 is only needed in configurations in which the air handling unit is comprised of multiple fans in parallel.

The control logic of Module 518 follows the same control logic as described for Module 508 [see the prior paragraph] expect that it activates and deactivates pumps rather than fans. Thus, as can be seen in Steps 524, 526 and 528 of FIG. 5, if the pump efficiency is less than the design pump efficiency by a predetermined value (about 5% for example, but not limited to this percentage), then Pump Load/Unload Module 518 activates the pumps of the chilled water pump system by comparing the ratio of the measured pump head over a square of the measured pump flow rate to the ratio of the design pump head over a square of the design pump flow rate. Module 518 inactivates a pump if the working point is on the left of the design point meaning that the ratio of the measured pump head over a square of the measured pump airflow rate is higher than the ratio of the design pump head over a square of the design pump airflow rate (see steps 526 and 530 in FIG. 5).

When device 302 is implemented in an air handling unit such as that shown in system 300, Fan Speed Control Module 532 controls the speed of the fan based on a comparison of the measured airflow rate and design airflow rates. As shown in steps 536 and 538 of FIG. 5, if the measured rate of airflow is greater than the high load airflow rate (adjustable rate of 80% of the design airflow), Module 532 modulates the fan speed so that the ratio of the fan head over the square of the fan airflow rate equals the ratio of the design fan head over the square of the design fan airflow rate (or the in-situ measured or adjusted value). If the measured rate of airflow is less than the high load but greater than the low load or heating flow rate (50% of the design airflow rate (this rate is adjustable)), Module 532 modulates the speed of the fan so that the ratio of the fan head over the square of the fan airflow is a function of the following equation:

$$\frac{h}{{Q}^{2 }} = ( 1 + \frac{{Q}_{h} - Q}{α {Q}_{h}} ) \frac{{h}_{d}}{{Q}_{d}^{2}}$$

### Where:

h is the fan head as measured by control device 302
Q is the airflow rate as measured by control device 302
Qh is the high load flow, or about 80% of the design airflow (this percentage is adjustable)
Hd is the design fan head
Qd is the design airflow rate
α-flow is the distribution factor [2] (the number is adjustable)
   Module 532 modulates the speed of the fan so that the airflow rate is at a low load flow rate (or at 50% of the design airflow rate, though this is adjustable) if the airflow rate is lower than the low load airflow rate (as shown in steps 540,542, and 544 of FIG. 5).

When device 302 is implemented in a pump system such as system 400 as shown in FIG. 4 of the drawings, Pump Speed Control Module 534 controls the speed of the pumps. The control method is similar to the method used for controlling the speed of the fans when device 302 is implemented in an air handling unit. Thus, as shown in steps 546 and 548 of FIG. 5, Module 534 compares the measured and design water flow rates. If the measured water flow rate is higher than the high load water flow rate (adjustable rate of 80% of the design water flow rate), Speed Control Module 534 modulates the pump speed so that the ratio of the pump head over the square of the pump flow rate is equal to the ratio of the design pump head over the square of the design pump water flow rate (or the in-situ measured or adjusted value). However, if the measured water flow rate is lower than the high load flow rate but higher than the low load flow rate (or 50% of the design heating flow rate (this rate is adjustable)), Module 534 modulates the speed of the pump so that the ratio of the pump head over the square of the pump water flow rate is a function of the equation shown previously. If the water flow rate is lower than the low load water flow rate (or 50% of the design water flow rate), the pump speed is modulated to maintain the low load water flow rate as shown in steps 550, 552, and 554 of FIG. 5.

While the method in which device 302 controls the pumps of chilled water pump systems and the fans of air handling units is similar, device 302 makes an additional calculation before solving for the pump speed ratio when implemented in chilled water pump systems like that shown in FIG. 3 (system 300). This is because the number of chillers in operation in a chilled water pump system significantly affects the design head and flow calculations. As such, in order to modulate the pump speed to maintain the ratio of the pump head and the square of the water flow rate as a function of the flow ratio according to the stated equation, it is first necessary to calculate for the design water flow rate and design pump head for each system configuration. For example, chilled water pump system 400 is comprised of two chillers (chillers 404 and 406). When both chillers are in operation they process water at a rate of 1000 GPM (gallons per minute). If the design pump head is 100 feet (ft). (60 ft. for the water distribution system and 40 ft. for the chiller and associated pipe), the pump head and water flow design ratio is 100 ft/1000/1000 or 0.0001 when chillers 404 and 406 are in operation. However, if one of the said chillers is not in operation (and the isolation valve closed to prevent the flow of chilled water through the chiller), the design head is instead 55 ft (40 ft. for the chiller and 15 ft. for the distribution loop or 0.025 multiplied by 60). In this scenario, the design water flow rate is 500 GPM. Thus, the ratio of the design pump head and the square of the design water flow rate becomes 0.00022 (55/500/500). It can therefore be seen that the addition of a chiller to the configuration of a chilled water pump system more than doubles the ratio. This additional chiller calculation for the pump system is shown in step 517 in FIG. 5.

Various features and advantages of the invention are set forth in the following claims.

What is claimed is:

1. A method of controlling at least one fan or pump to optimize the transport of liquids and/or gases through a system having at least one variable speed drive, said method comprising:
interfacing a control device with said system;
inputting a plurality of system operating conditions comprising a VFD current value, VFD power value, VFD torque value, and VFD speed value from said variable speed drive into said control device;
inputting a performance curve, a design flow rate, a design high load flow rate and design low load flow rate into said control device;
calculating, by said controller, for a measured power value based on said VFD power value;
determining, by said controller, a measured flow rate based on said performance curve, VFD current value, VFD power value, and VFD torque value;
determining, by said controller, a measured head value based on said measured power value and said performance curve;
determining, by said controller, a design point efficiency based on said measured flow rate and said measured head value;
identifying, by said controller, a working point efficiency on said performance curve;
activating, by said controller, said at least one fan or pump when said design point efficiency is less than said working point efficiency by a predetermined amount and a ratio of said measured head value over a square of said measured flow rate is lower than a ratio of said design head value over a square of said design flow rate;
inactivating, by said controller, at least one fan or pump when said design point efficiency is less than said working point efficiency within a predetermined range and a ratio of said measured head value over a square of said measured flow rate is greater than a ratio of said design head value over a square of said design flow rate;
modulating, by said controller, a speed of said at least one fan or pump so that a ratio of said measured head value over a square of said measured flow rate is equal to a ratio of said design head value over a square of said design flow rate when said measured flow rate is greater than said design high load flow rate;
modulating, by said controller, a speed of said fan or pump to maintain said low load flow rate when said measured flow rate is lower than said design low load flow rate;
modulating, by said controller, a speed of said at least one fan or pump when said measured flow rate is less than said design high load rate and greater than said design low load rate, so that a ratio of said measured head value over a square of said measured flow is equal to one plus said design high load flow minus said measured flow rate over said design high load flow multiplied by a distribution factor and further multiplied by said design head over said design flow rate squared.

2. The method of claim 1 in which said system is an air handling unit.

3. The method of claim 1 in which said system is a chilled water pump system having at least one chiller.

4. The method of claim 3, wherein said performance curve is a pump performance curve, and said high load flow rate and low load flow rate is a high load water flow rate and low load water flow rate.

5. The method of claim 2, wherein said performance curve is a fan performance curve, and said high load flow rate and low load flow rate is a high load air flow rate and low load air flow rate.

6. The method of claim 3, further comprising calculating, by said controller, for said measured water flow rate and measured head for said at least one chiller.

7. A control device configured to control a system having at least one pump or fan and at least one variable speed drive, said control device comprising:
an input module configured to input a plurality of operating conditions from said variable speed drive comprising a VFD current value, a VFD power value, a VFD torque value, and a VFD speed value and a plurality of predetermined variables for said system comprising a performance curve, a design flow rate, a design low load flow rate, a design high load flow rate,;
a power module configured to calculate for a measured power value based on said VFD power value;
a head, flow rate, and efficiency module configured to calculate for a head value based on said measured power value and said performance curve, a measured flow rate value based on said VFD current value, said VFD power value, said VFD torque value, and said performance curve, and an efficiency value based on said measured flow rate and measured head value;
a load/unload module configured to stage and modulate a speed of said at least one pump or fan, said module comprising:
an identifying step for identifying a working point efficiency on said performance curve;
an activation step for activating said at least one fan or pump when said efficiency value is less than said working point efficiency by a predetermined amount and a ratio of said measured head value over a square of said measured flow rate is lower than a ratio of said design head value over a square of said design flow rate;
a deactivation step for deactivating said at least one fan or pump when said efficiency value is less than said working point by a predetermined amount and a ratio of said measured head value over a square of said measured flow rate is greater than a ratio of said design head value over a square of said design flow rate;
a first speed modulation step for controlling a speed of said at least one fan or pump when said measured flow rate is greater than said design high load flow rate so that a ratio of said measured head value over a square of said measured flow rate is equal to a ratio of said design head value over a square of said design flow rate and said measured flow rate is greater than said design high load flow rate;
a second speed modulation step for controlling a speed of said at least one fan or pump to maintain said low load flow rate when said measured flow rate is less than said low load airflow rate;
a third speed modulation step for controlling a speed of said at least one fan or pump when said measured flow rate is less than said design high load rate and greater than said design low load rate, and a ratio of said measured head value over a square of said measured flow rate is equal to one plus said design high load flow rate minus said measured flow rate over said design high load flow rate multiplied by a distribution factor and further multiplied by said design head over said design flow rate squared.

8. The control device of claim 7, wherein said system is an air handling unit.

9. The control device of claim 7, wherein said system is a chilled water pump system having at least one chiller.

10. The control device of claim 9, wherein said head, flow rate, and efficiency module further comprises a chiller number calculation step configured to calculate for said design water flow rate and design head for said at least one chiller.

11. The control device of claim 8, wherein said air handling unit is absent a static pressure sensor.

12. The control device of claim 8, wherein said air handling unit is absent a conventional flow meter.

13. The control device of claim 9, wherein said chilled water system is absent a differential pressure sensor.

14. The control device of claim 9, wherein said chilled water pump system having at least one chiller is absent a conventional flow meter.

15. The control device of claim 9, wherein said chilled water pump system having at least one chiller is absent a differential pressure sensor.

16. The control device of claim 9, wherein said performance curve is a pump performance curve, and said design high load flow rate and design low load flow rate is a design high load water flow rate and design low load water flow rate.

17. The control device of claim 8, wherein said performance curve is a fan performance curve, and said design high load flow rate and design low load flow rate is a design high load air flow rate and design low load air flow rate.

18. The control device of claim 7, wherein said control device is sensorless.
